(19) United States
(12) Patent Application Publication
(10) Pub. No.: US 2025/0235939 A1
(43) Pub. Date: Jul. 24, 2025

(54) POWERED REBAR CUTTER

(71) Applicant: MILWAUKEE ELECTRIC TOOL CORPORATION, Brookfield, WI (US)

(72) Inventors: Alexander C. Ghouse, Ixonia, WI (US); Mitchell Eckstrand, Milwaukee, WI (US); Erik A. Freeberg, Oconomowoc, WI (US); Anthony R. Sleck, Lisbon, WI (US)

(21) Appl. No.: 19/013,104

(22) Filed: Jan. 8, 2025

Related U.S. Application Data
(60) Provisional application No. 63/707,572, filed on Oct. 15, 2024.
(60) Provisional application No. 63/631,827, filed on Apr. 9, 2024.
(60) Provisional application No. 63/622,950, filed on Jan. 19, 2024.

(51) Int. Cl. B23D 29/00; B26D 5/08

(52) U.S. Cl. CPC B23D 29/002; B26D 5/086

(57) ABSTRACT

A power tool including a housing defining a longitudinal axis, a motor having a motor output shaft, a gear case, and a blade guard which partially receives a rotating blade. The powered rebar cutter includes a gear train at least partially received within the gear case and configured to transfer torque from the motor output shaft to a blade and includes an arbor and a single intermediate shaft that transfers torque from the motor output shaft to the arbor. The gear train includes a pinion gear coupled for co-rotation with the motor output shaft and a ring gear coupled for co-rotation with the intermediate shaft and meshed with the pinion gear. The ring gear is located between a first plane defined by the blade and a parallel, second plane containing a rotational axis of the motor output shaft.

### CROSS-REFERENCE TO RELATED APPLICATIONS

The application claims priority to U.S. Provisional Patent Application No. 63/707,572, filed Oct. 15, 2024, U.S. Provisional Patent Application No. 63/631,827, filed Apr. 9, 2024, and U.S. Provisional Patent Application No. 63/622,950, filed Jan. 19, 2024, the entire contents of all of which are incorporated by reference herein.

### FIELD OF THE INVENTION

The present invention relates to cordless power tools, and more particularly to powered rebar cutters.

### BACKGROUND OF THE INVENTION

Powered rebar cutters utilize a cutting blade to cut a work piece, such as rebar.

### SUMMARY OF THE INVENTION

The present invention provides, in one aspect, a power tool including a housing defining a longitudinal axis, a motor received within the housing and including a motor output shaft, a gear case coupled to the housing, and a blade guard coupled to the gear case in which a rotating blade is at least partially received. The powered rebar cutter includes a gear train at least partially received within the gear case and configured to transfer torque from the motor output shaft to the blade. The gear train includes an arbor to which the blade is coupled for co-rotation therewith, and a single intermediate shaft positioned between the motor output shaft and the arbor. The intermediate shaft is configured to transfer torque from the motor output shaft to the arbor. The gear train includes a pinion gear coupled for co-rotation with the motor output shaft and a ring gear coupled for co-rotation with the intermediate shaft and meshed with the pinion gear. The ring gear is located between a first plane defined by the blade and a parallel, second plane containing a rotational axis of the motor output shaft.

The present invention provides, in another aspect, a powered rebar cutter including a housing defining a longitudinal axis, a motor received within the housing, a gear case coupled to the housing, a blade guard coupled to the gearcase, the blade guard including an opening extending in a direction of the longitudinal axis in which rebar is received during a cutting operation by a blade, a gear train at least partially received within the gearcase and configured to transfer torque from the motor to the blade, and a lighting assembly configured to project light onto the opening to illuminate a portion of the blade exposed through the opening in the blade guard.

The present invention provides, in another aspect, a powered rebar cutter including a housing defining a longitudinal axis, a motor received within the housing, a gear case coupled to the housing, a blade guard coupled to the gearcase, the blade guard including an opening extending in a direction of the longitudinal axis in which rebar is received during a cutting operation by a blade, a gear train at least partially received within the gearcase and configured to transfer torque from the motor to the blade, the gear train including an arbor to which the blade is affixed, and a blade cover pivotably coupled to the blade guard between a closed position, in which the blade guard and blade cover collectively define a chamber in which the blade is rotatable, and an open position in which the arbor is accessible to remove the blade.

The present invention provides, in another aspect, a powered rebar cutter including a housing defining a longitudinal axis, a motor received within the housing, a gear case coupled to the housing, a blade guard coupled to the gearcase, the blade guard including an opening extending in a direction of the longitudinal axis in which rebar is received during a cutting operation by a blade, a gear train at least partially received within the gearcase and configured to transfer torque from the motor to the blade, the gear train including an arbor to which the blade is affixed, and a dust chute at least partially defined by the blade guard and oriented along a central axis that is obliquely oriented relative to the longitudinal axis of the housing.

The present invention provides, in another aspect, a power tool including a housing defining a longitudinal axis, a motor received within the housing, a gear case coupled to the housing, a blade having an aperture, a blade guard coupled to the gearcase in which the blade is at least partially received, and a gear train at least partially received within the gearcase. The gear train configured to transfer torque from the motor to the blade. The gear train includes an arbor having a lower recess defining a diameter. The powered rebar cutter includes a locking flange and a fastener. The fastener is configured to couple the locking flange to the arbor such that the blade is clamped between the arbor and the locking flange. The locking flange includes a first cylindrical portion configured to be received in the lower recess of the arbor and a second cylindrical portion that defines a second diameter that is greater than the first diameter of the lower recess. The second cylindrical portion is received within the aperture of the blade.

### BRIEF DESCRIPTION OF THE DRAWINGS

FIG. 1 is a top perspective view of a powered rebar cutter.

FIG. 2 is a bottom perspective view of the powered rebar cutter of FIG. 1.

FIG. 3 is a cross-sectional view of the powered rebar cutter of FIG. 1, taken along section 3-3 in FIG. 1.

FIG. 4 is an enlarged view of a gear train of the powered rebar cutter of FIG. 3.

FIG. 5 is a top view of the powered rebar cutter of FIG. 1.

FIG. 6 is an enlarged, front view of the powered rebar cutter of FIG. 1, illustrating a lighting assembly.

FIG. 7 is the magnified view of the lighting assembly of the powered rebar cutter of FIG. 6 with a gear case cover removed.

FIG. 8A is an enlarged, front view of another embodiment of a powered rebar cutter, illustrating another lighting assembly.

FIG. 8B is a top view of the lighting assembly of the powered rebar cutter of FIG. 8A with a gear case cover removed.

FIG. 9 is an enlarged, front perspective view of another embodiment of a powered rebar cutter, illustrating a lighting assembly.

FIG. 10 is a bottom perspective view of the powered rebar cutter of FIG. 9 with portions removed.

FIG. 11 is an enlarged perspective view of another embodiment of the powered rebar cutter, illustrating onboard storage for a hex key.

FIG. 12 is a top perspective view of another embodiment of a powered rebar cutter.

FIG. 13 is an enlarged perspective view of the powered rebar cutter of FIG. 12, illustrating a battery receptacle.

FIG. 14 is a cross-sectional view of the powered rebar cutter of FIG. 12, taken along section 14-14 in FIG. 12.

FIG. 15 is an enlarged view of the arbor of the powered rebar cutter of FIG. 14.

FIG. 16 is an enlarged view of another embodiment of a cutting blade for use with the powered rebar cutter of FIG. 12.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

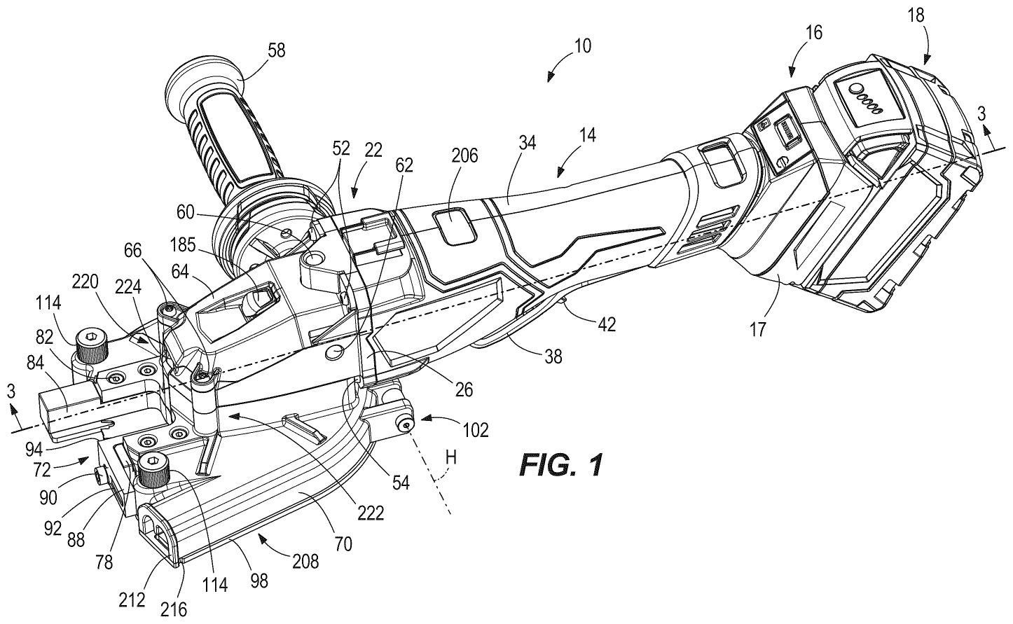

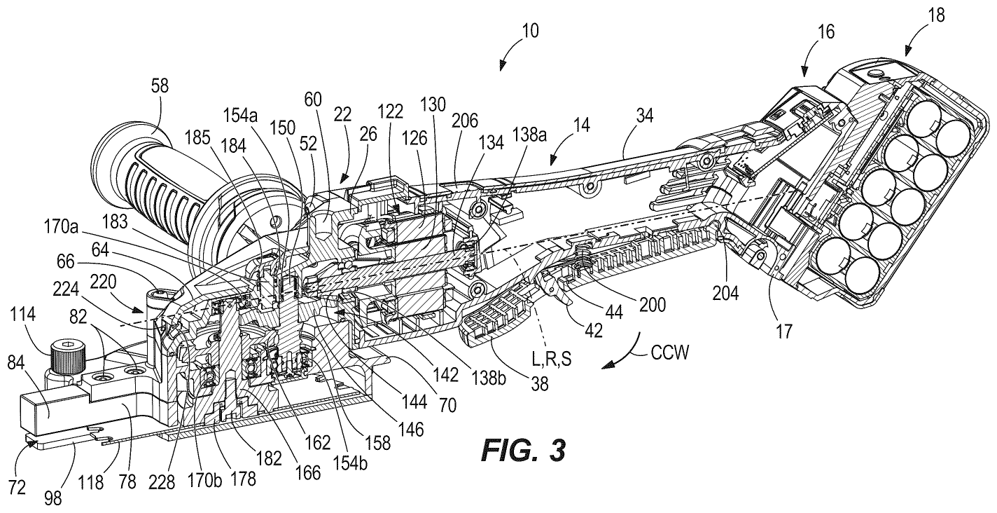

FIG. 1 illustrates a power tool 10 (i.e., a powered rebar cutter) including a housing 14 having a first end 16 with a battery receptacle 17 configured to receive a battery pack 18 and second end 22 coupled to a gear case 26. The housing 14 defines a longitudinal axis L that also extends though the gear case 26 (FIG. 3). The housing 14 includes a grip 34 configured to be grasped by a user (see also FIG. 1). In some embodiments, the grip 34 is made of a material that is different from the housing 14 to optimize user grip. In the illustrated embodiment of the powered rebar cutter 10, the grip 34 is made from a thermoplastic elastomer, which is overmolded to the housing 14. The housing 14 includes a trigger (e.g., a paddle 38) configured to be engaged by the user to activate the powered rebar cutter 10. The paddle 38 includes a lockout lever 42 that is pivotally coupled to the paddle 38 (FIG. 3). To successfully actuate the paddle 38, the user must first pivot the lockout lever 42 counterclockwise relative to the frame of reference of FIG. 3 until the lockout lever 42 is received within a recess 44 in the paddle 38.

In some embodiments, the battery pack 18 may be an 18-volt rechargeable power tool battery pack. The battery pack 18 may include multiple battery cells having, for example, a lithium (Li), lithium-ion (Li-ion), or other lithium-based chemistry. For example, the battery cells may have a chemistry of lithium-cobalt (Li—Co), lithium-manganese (Li—Mn) spinel, or Li—Mn nickel. In such embodiments, each battery cell may have a nominal voltage of about, for example, 3.6V, 4.0V, or 4.2V. In other embodiments, the battery cells may have a nickel-cadmium, nickel-metal hydride, or lead acid battery chemistry. In further embodiments, the battery pack 18 may include fewer or more battery cells, and/or the battery cells may have a different nominal voltage. In yet another embodiment, the battery pack 18 may be a dedicated battery housed (partially or entirely) within the powered rebar cutter 10. The battery pack 18 may also be configured for use with other cordless power tools, such as drills, screwdrivers, grinders, wrenches, and saws.

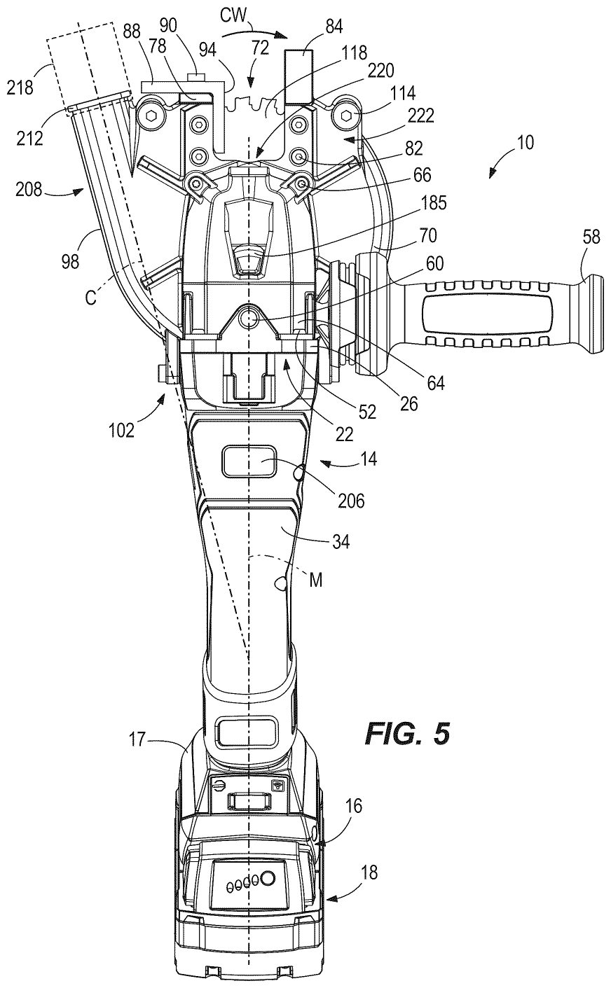

With reference to FIG. 1, the gear case 26 is coupled to the second end 22 of the housing 14 with a first pair of fasteners 52 and second pair of fasteners 54. The gear case 26 receives an auxiliary handle 58 via a threaded aperture (not shown) in the gear case 26. In some embodiments, the user may remove the auxiliary handle 58 from the powered rebar cutter 10 and use the powered rebar cutter 10 without the auxiliary handle 58. In some embodiments, the user may reposition the auxiliary handle 58 on the cutter, for example, to a second threaded aperture 60 in the gear case 26. As shown in FIG. 5, the second threaded aperture 60 is perpendicular to the threaded aperture that receives the auxiliary handle 58 when in the position shown in FIG. 1. A third threaded aperture 62 may be included in the gear case 26 on an opposite side of a plane M (FIG. 5). The plane M bisects the second threaded aperture 60 and contains the longitudinal axis L. In some embodiments, the auxiliary handle 58 may include a sensor (e.g., a capacitive sensor, not shown) to detect the presence of the user's hand on the auxiliary handle 58, thereby only permitting activation of the powered rebar cutter 10 if the user is grasping the auxiliary handle 58. A gear case cover 64 (FIG. 1) is coupled to the gear case 26 via the first pair of fasteners 52 and a third pair of fasteners 66.

With continued reference to FIG. 1, the powered rebar cutter 10 includes a blade guard 70 coupled to the gear case 26 with the third pair of fasteners 66. The blade guard 70 includes a gap or an opening 72 (e.g., a front opening) in which rebar is received. In the illustrated construction, the opening 72 is disposed on a side of the blade guard 70 that is opposite from the side of the blade guard 70 coupled to the housing 14. In other constructions, the opening 72 is disposed on a side of the blade guard 70 that is opposite from a side having the pair of fasteners 66. The front opening 72 extends in a direction of the longitudinal axis L. A guide block 78 is coupled to the blade guard 70 with guide block fasteners 82. The guide block 78 is formed in a U-shape and includes a protrusion 84. The protrusion 84 is configured to position the front opening 72 of the powered rebar cutter 10 about a work piece, such as a piece of rebar. The guide block 78 supports a front area adjuster 88 adjacent the front opening 72 with a fastener 90. The front area adjuster 88 includes a horizontal slot 92 configured to receive the fastener 90. For the user to fix the front area adjuster 88, the fastener 90 must be tightened to clamp the front area adjuster 88 to the guide block 78. The front area adjuster 88 may be adjusted along the length of the horizontal slot 92 to enlarge or narrow the front opening 72, thereby restricting the effective width of the front opening 72. For the user to narrow the effective width of the front opening 72, the user slides a side 94 of the front area adjuster 88 toward the protrusion 84. For the user to enlarge the effective width of the front opening 72, the user slides the side 94 away from the protrusion 84.

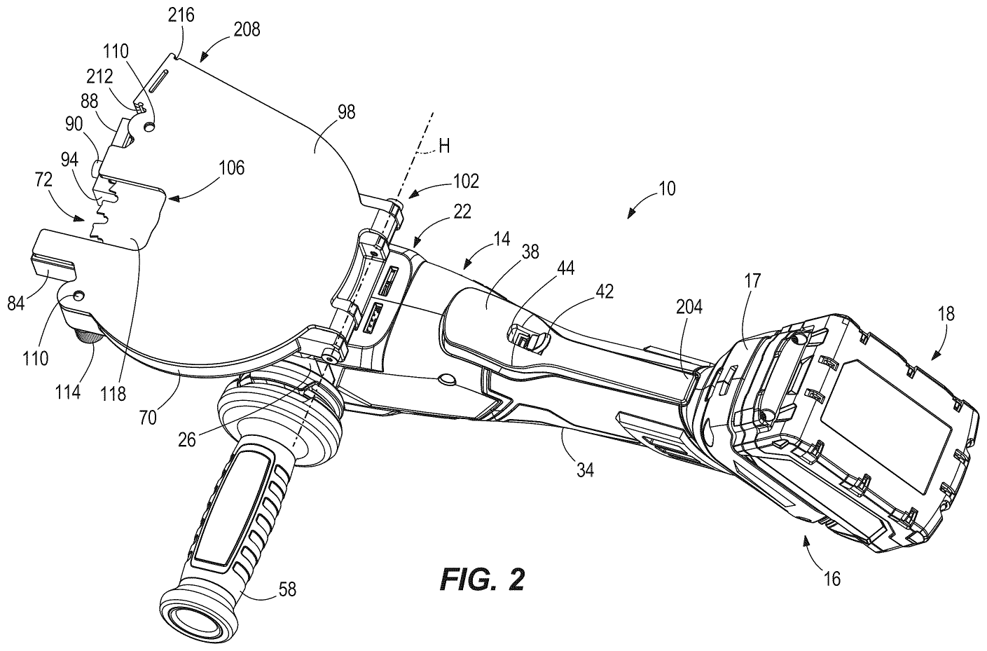

With reference to FIGS. 1 and 2, the powered rebar cutter 10 includes a blade cover 98 that is pivotally coupled to the blade guard 70 via a pair of hinges 102. As shown in FIG. 2, the blade cover 98 substantially replicates the outer profile of the blade guard 70. For instance, the blade cover 98 includes an opening 106 that mimics the shape of the front opening 72 of the blade guard 70. As such, the opening 106 of the blade cover 98 partially defines the front opening 72. The blade cover 98 includes a pair of threaded apertures 110 configured to receive blade cover fasteners 114, which extend through the blade guard 70 and engage the blade cover 98 to maintain it in a closed position. In the illustrated embodiment, the blade cover fasteners 114 are a combination fastener (e.g., a combination of a thumb screw with a hex head). In other embodiments, the blade cover fasteners 114 may exclusively be a thumb screw or a hex head screw). For the user to access a cutting blade 118 of the powered rebar cutter 10, blade cover fasteners 114 are unthreaded from the threaded apertures 110 such that the blade cover 98 is free to pivot about the hinges 102 defining an axis H. The axis H is parallel to the auxiliary handle 58. In other embodiments, the hinges 102 may be oriented to be parallel to the blade cover fasteners 114. In the instance that the hinge 102 is parallel to the blade cover fasteners 114, the blade cover 98 would pivot clockwise and counterclockwise when looking at a top surface of the gear case 26. To secure the blade cover 98, the user positions the blade cover 98 flush with the blade guard 70 such that the blade cover fasteners 114 are threaded into the threaded apertures 110. Accordingly, the blade cover 98 is pivotable between a closed position in which the blade cover 98 and the blade guard 70 collectively define a chamber in which the cutting blade 118 is rotatable, and an open position in which the blade cover 98 is released from the blade guard 70 (i.e., the blade cover fasteners 114 are removed from the threaded apertures 110) so the blade cover 98 can pivot away from the blade guard 70 and expose the cutting blade 118 for removal and/or replacement.

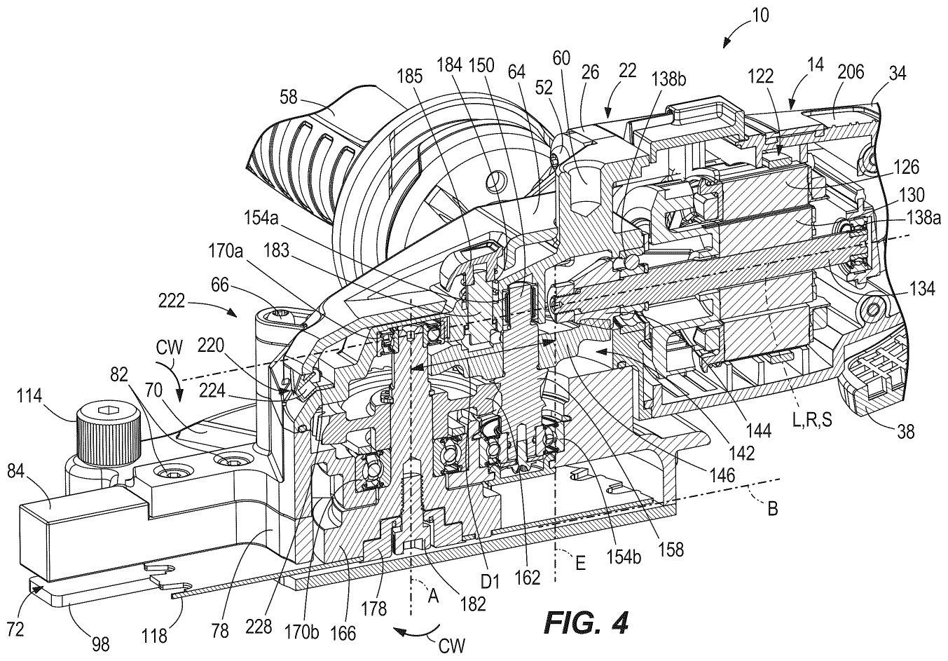

FIGS. 3 and 4 illustrate the powered rebar cutter 10 including a motor 122 received within the housing 14. The motor 122 includes a stator 126 fixed to the housing 14 and a rotor 130 that is rotatably supported within the housing 14. The motor 122 includes a motor output shaft 134 coupled for co-rotation with the rotor 130 about a rotational axis R of the motor output shaft 134 by a pair of bearings 138a, 138b. In the illustrated embodiment, the rotational axis R and the longitudinal axis L are coaxial. The bearing 138a is supported by the housing 14, whereas the bearing 138b is supported by the gear case 26.

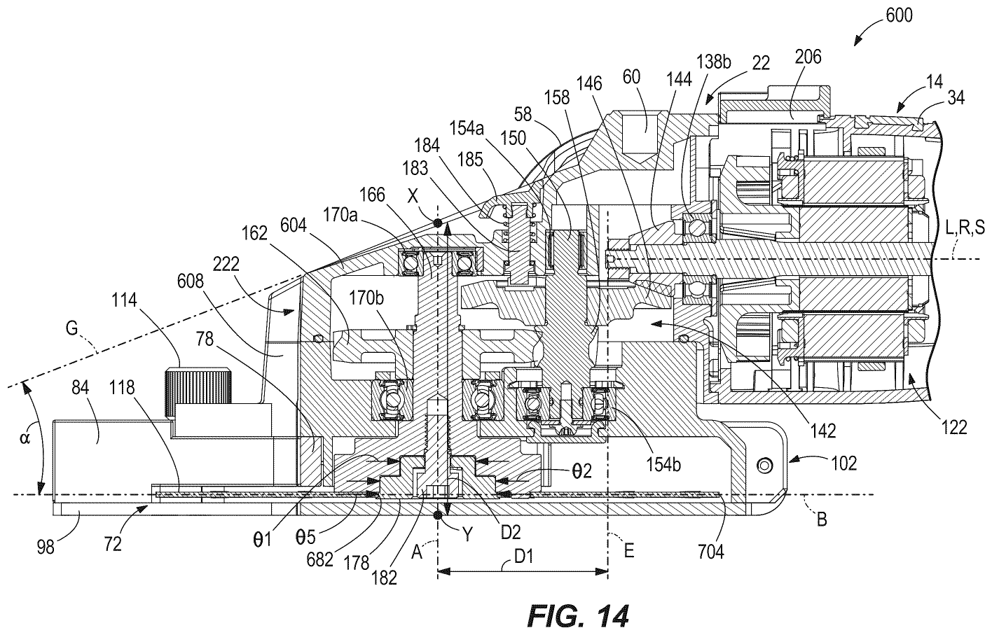

FIGS. 3 and 4 illustrate a gear train 142, which is partially received within the gear case 26 and is configured to transmit torque from the motor 122 to the cutting blade 118. The cutting blade 118 defines a plane B (FIGS. 4 and 14). The gear train 142 includes a pinion gear 144 that is coupled to the front end of the motor output shaft 134 and that extends past the bearing 138b. The pinion gear 144 is coupled to the motor output shaft 134 by a left-hand thread arrangement and is coupled for co-rotation with the motor output shaft 134. The motor output shaft 134 and the pinion gear 144 are rotated in a clockwise (CW) direction from a frame of reference (FIG. 4) along the rotational axis R of the motor output shaft 134 looking at a front of the powered rebar cutter 10. A plane S contains the rotational axis R and is parallel to the plane B. The gear train 142 also includes an intermediate bevel gear (i.e., a ring gear 146) meshed with the pinion gear 144. The ring gear 146 is located between the plane B and the parallel plane S. The intermediate ring gear 146 is coupled to a single intermediate shaft 150 for co-rotation therewith. The intermediate shaft 150 is oriented perpendicular to the motor output shaft 134. Since the intermediate shaft 150 is coupled for co-rotation with the intermediate ring gear 146, the pinion gear 144 drives the intermediate shaft 150. The intermediate shaft 150 is rotatably supported by a pair of intermediate shaft bearings 154a, 154b. A first intermediate shaft bearing 154a is received within a pocket in the gear case 26 and a second intermediate shaft bearing 154b is received within a pocket in the blade guard 70. The intermediate shaft 150 includes a drive gear 158 that is coupled to the intermediate shaft 150 for co-rotation. The drive gear 158 is meshed with a driven gear 162 that is coupled to an arbor 166 for co-rotation. The drive gear 158 is located between the plane B and the ring gear 146. The arbor 166 is oriented parallel to the intermediate shaft 150. The arbor 166 is rotatably supported by a pair of arbor bearings 170a, 170b. A first arbor bearing 170a is received within a pocket in the gear case 26 and a second intermediate shaft bearing 154b is received within a pocket in the blade guard 70. The cutting blade 118 is coupled to the arbor 166 for co-rotation therewith and is axially affixed to the arbor 166 by a locking flange 178 which, in turn, is clamped to the arbor 166 with a fastener 182. The arbor 166 is rotated in a clockwise (CW) direction from a frame of reference (FIG. 4) along a rotational axis A of the arbor 166 looking at a top surface of the gear case 26. An end surface of the motor output shaft 134 defines a plane E (FIGS. 4 and 14). A distance D1 between the plane E and the rotational axis A of the arbor 166 is between 40 millimeters and 50 millimeters. In the illustrated embodiment, the distance D1 is 46 millimeters.

The powered rebar cutter 10 includes a locking pin 183 that is biased in a first direction via a spring 184. The locking pin 183 is received on a top surface of the gear case 26, which is angled relative to the plane B. The locking pin 183 includes an abutment member 185 configured to be biased by the user in a second direction such that the locking pin 183 is received in a recess or a hole (not shown) in the intermediate ring gear 146. Engagement of the locking pin 183 with the recess or hole of the intermediate ring gear 146 will prevent rotation of the intermediate ring gear 146 and therefore the gear train 142. In other words, engagement of the locking pin 183 with the intermediate ring gear 146 will rotationally lock the intermediate ring gear 146 and therefore the entire gear train 142.

For the user to remove the cutting blade 118, the blade cover 98 must be in the open position. Specifically, the blade cover fasteners 114 must be disengaged from the threaded apertures 110 such that the blade cover 98 pivots about the hinges 102 to expose the fastener 182 coupled to the arbor 166. To remove the cutting blade 118, the fastener 182 must be removed such that the locking flange 178 disengages the cutting blade 118. The user may push the locking pin 183 via the abutment member 185 in the second direction to cause the locking pin 183 to engage and rotationally lock the intermediate ring gear 146, such that the arbor 166 does not rotate when the fastener 182 is being loosened from the arbor 166. The locking flange 178 releases its clamping force on the cutting blade 118 upon the fastener 182 being unthreaded from the arbor 166, which enables the user to remove the cutting blade 118. The cutting blade 118 includes a diameter between 125 millimeters and 140 millimeters. In the illustrated embodiment, the diameter is 137 millimeters.

Similarly, for the user to attach the cutting blade 118, the blade cover 98 must be in the open position. The user may push the locking pin 183 via the abutment member 185 in the second direction to cause the locking pin 183 to engage and rotationally lock the intermediate ring gear 146, such that the arbor 166 does not rotate when the fastener 182 is being tightened to the arbor 166 with the locking flange 178 therebetween. The locking flange 178 engages the cutting blade 118 to be flush with a surface of the arbor 166 when the fastener 182 is completely fastened. The user may return the blade cover 98 to the closed position so that the blade cover fasteners 114 can re-engage the threaded apertures 110.

For the user to activate the powered rebar cutter 10 to perform a cutting operation on a workpiece (e.g., a piece of rebar), the user must pivot the lockout lever 42 counterclockwise such the lockout lever 42 is received in the recess 44 of the paddle 38 and depress the paddle switch 38 against a biasing member (e.g., spring 200) disposed between the housing 14 and the paddle 38. As the paddle 38 pivots about a hinge 204 toward the housing 14, an electrical switch (not shown) is actuated to activate the motor 122 with electrical current supplied from the battery pack 18. Rotation of the motor output shaft 134 is transferred to the intermediate ring gear 146 via the pinion gear 144. The rotation of the intermediate ring gear 146 is transferred to the driven gear 162 via the intermediate shaft 150 and the drive gear 158. The arbor 166 co-rotates with the driven gear 162, thereby transferring torque to the cutting blade 118 to cause it to rotate. The powered rebar cutter 10 includes a controller that is configured to control braking of the powered rebar cutter 10 by monitoring the phase voltage of the motor 122, as described at least in U.S. Pat. No. 11,557,989, the entire content of which is incorporated herein by reference. The powered rebar cutter 10 includes a braking or stop switch 206 that signals the controller to initiate braking. Additionally, the powered rebar cutter 10 includes a cut stop feature to detect when the powered rebar cutter 10 is fished cutting through a workpiece, as described at least in U.S. Pat. No. 10,562,116, the entire content of which is incorporated herein by reference.

FIG. 5 illustrates the powered rebar cutter 10 including a dust chute 208. The dust chute 208 is defined by the blade guard 70 and the blade cover 98, when in the closed position, and extends along a central axis C. The central axis C is obliquely oriented relative to the plane M and the longitudinal axis L. The dust chute 208 is also tangentially oriented to the cutting blade 118 such that dust and debris are discharged from the powered rebar cutter 10 and away from the user. In the illustrated embodiment, the dust chute 208 is angled such that it successfully captures dust and debris when the cutting blade 118 rotates clockwise (CW) from the frame of reference of FIG. 5. In other embodiments, the rotation of the cutting blade 118 is counterclockwise and therefore the dust chute would be located on the opposite side of the plane M. The dust chute 208 includes a rib 212 defined at an end of the dust chute 208 and an adjacent notch 216. The powered rebar cutter 10 further includes a removable debris receptacle 218 that is selectively coupled to the rib 212 and the notch 216 with a retaining clip (not shown) received within the notch 216. In some embodiments, the removable debris receptacle 218 is a chip bag.

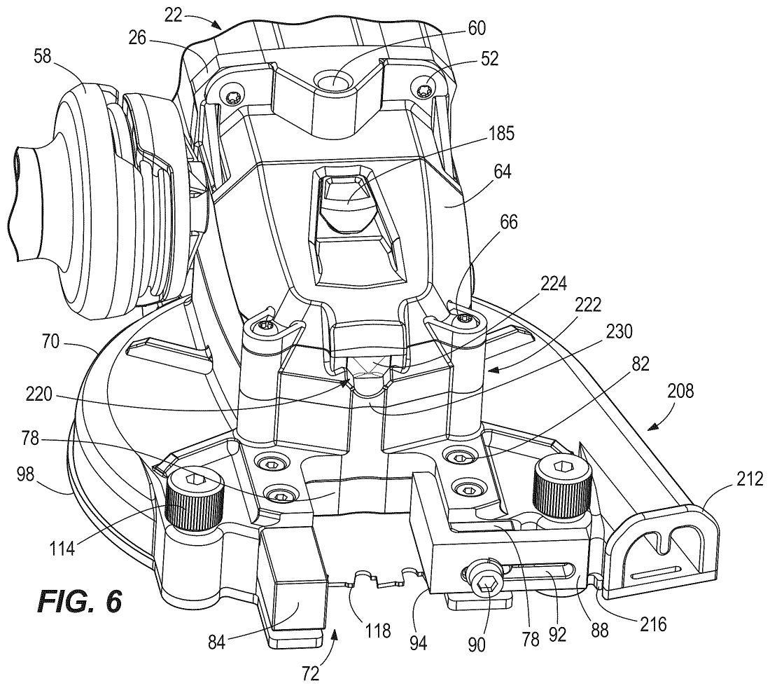

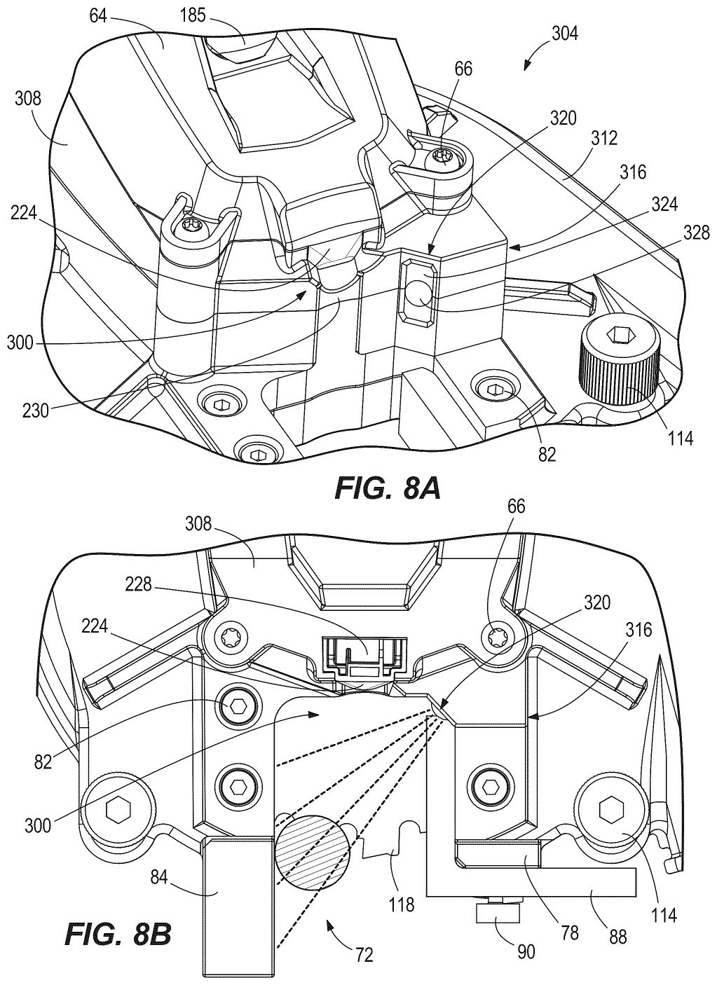

FIG. 6 illustrates the powered rebar cutter 10 including a lighting assembly 220 coupled to a front end 222 of the powered rebar cutter 10. Specifically, the lighting assembly 220 is disposed on the gear case 26. The lighting assembly 220 includes a lens 224 configured to direct light toward a portion of the cutting blade 118 exposed through the front opening 72. The lens 224 is disposed between the gear case 26 and the gear case cover 64 and is proximal to the front opening 72. More specifically, the lens 224 is disposed symmetrically about the plane M that bisects the gear case 26. In some embodiments, the lens 224 is comprised of polycarbonate. The lighting assembly 220 also includes a light source (e.g., a light emitting diode or “LED” 228; FIG. 8B) disposed on the gear case 26. When activated, the LED 228 illuminates the portion of the cutting blade 118 exposed through the front opening 72. The LED 228 receives electrical current from wires (not shown) that are routed through and/or around the gear case 26. The gear case 26 includes a notch 230 through which light from the LED 228 can pass through to reach the front opening 72.

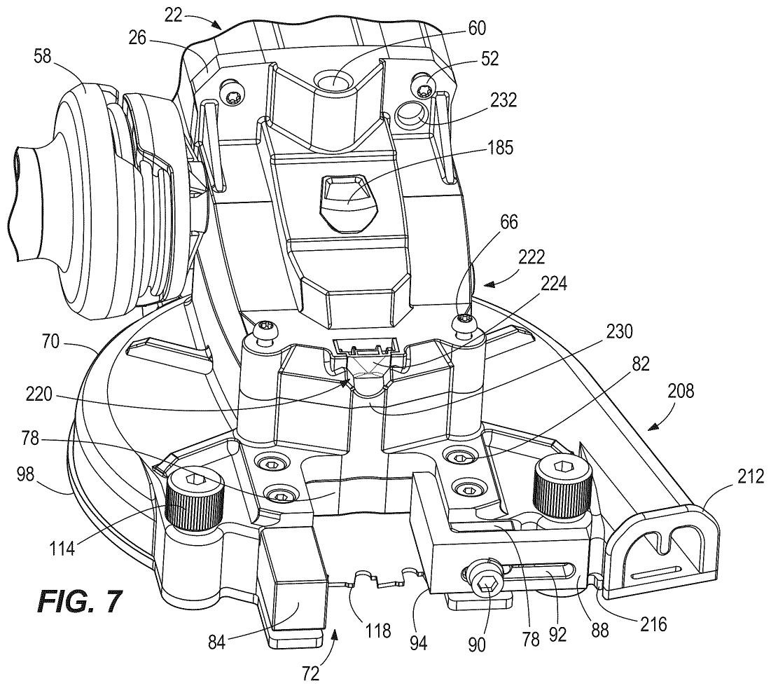

FIG. 7 illustrates the powered rebar cutter 10 with the gear case cover 64 removed. In some embodiments, the electrical wires connected to the LED 228 are routed around the exterior of the gear case 26 and through an aperture 232 in the gear case 26, around the motor 122, and to a printed circuit board assembly (not shown). In some embodiments, the LED 228 is activated in response to the user depressing the paddle 38.

FIGS. 8A and 8B illustrate a lighting assembly 300 for use with another embodiment of a powered rebar cutter 304, with like features as the powered rebar cutter 10 being identified with like reference numerals. The powered rebar cutter 304 includes a gear case 308 and a blade guard 312. The gear case 308 and the blade guard 312 define a protrusion 316 that includes an angled surface 320 angled toward the portion of the cutting blade 118 exposed through the front opening 72. The lighting assembly 300 includes the lens 224 and the LED 228. The lighting assembly 300 further includes a second lens 324 that is disposed on the angled surface 320 and an LED 328 disposed behind the lens 324. The LED 328 also illuminates the portion of the cutting blade 118 exposed through the front opening 72; however, any shadows otherwise created by a piece of rebar positioned in the front opening 72 blocking the light emitted from the LED 228 are avoided with the additional light emitted from the LED 328.

Since the LED 328 is disposed between the gear case 308 and the blade guard 312, electrical wires to supply electrical current to the LED 328 are routed through a chamber defined between the gear case 308 and the blade guard 312. In some embodiments, the gear case 308 includes a conduit (not shown) to enable a wire to be routed to the chamber defined between the gear case 308 and the blade guard 312 and to power the LED 328.

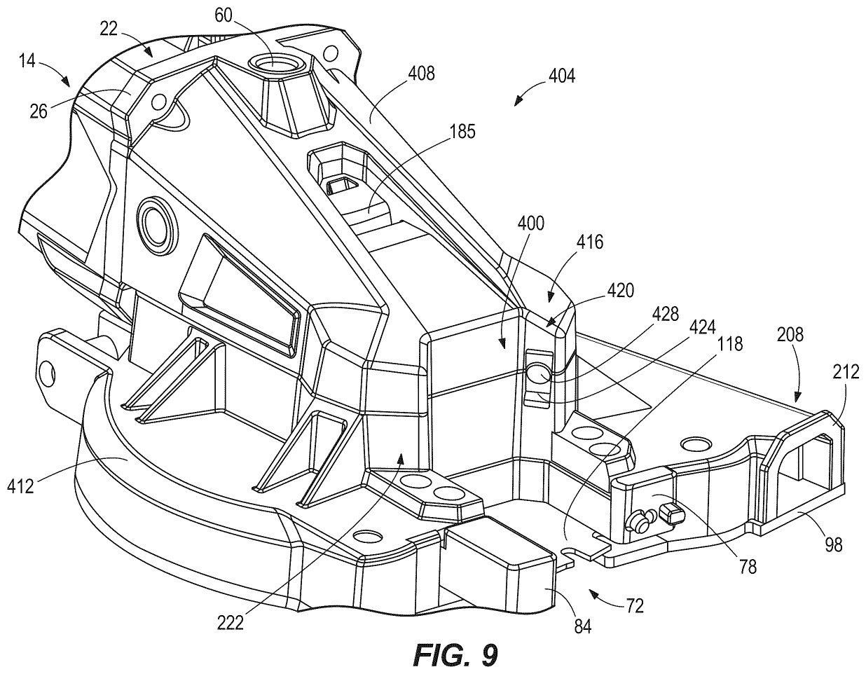

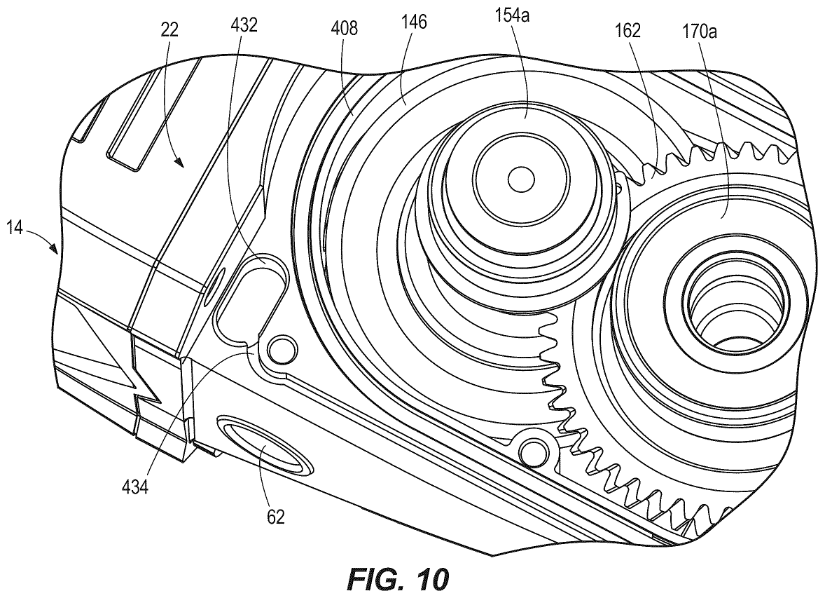

FIG. 9 illustrates a lighting assembly 400 for use with another embodiment of a powered rebar cutter 404, with like features as the powered rebar cutter 10 being identified with like reference numerals. The powered rebar cutter 404 includes a gear case 408 and a blade guard 412 that define a protrusion 416 that includes an angled surface 420 angled toward the portion of the cutting blade 118 exposed through the front opening 72. The lighting assembly 400 includes a lens 424 disposed on the angled surface 420. A light source (e.g., an LED 428) is disposed behind the lens 424, which directs light emitted from the LED 428 across the portion of the cutting blade 118 exposed through the front opening 72. When activated, the LED 428 illuminates the portion of the cutting blade 118 exposed through the front opening 72. The LED 428 receives electrical current from electrical wires (not shown) that are routed through and/or around the gear case 408. In the illustrated embodiment shown in FIG. 10, the gear case 408 includes an aperture 432 through which the electrical wires are routed. FIG. 10 illustrates the powered rebar cutter 404 with the blade guard 412 removed to illustrate the aperture 432, which leads to the interior of the housing 14, and a channel 434 within the gear case 408 extending between the aperture 432 and the front end of the gear case 408 where the LED 428 is located. The electrical wires extend between the LED 428 and the aperture 432 and are nested within the channel 434. When the blade guard 412 is fastened to the gear case 408, the electrical wires are held captive in the channel 434.

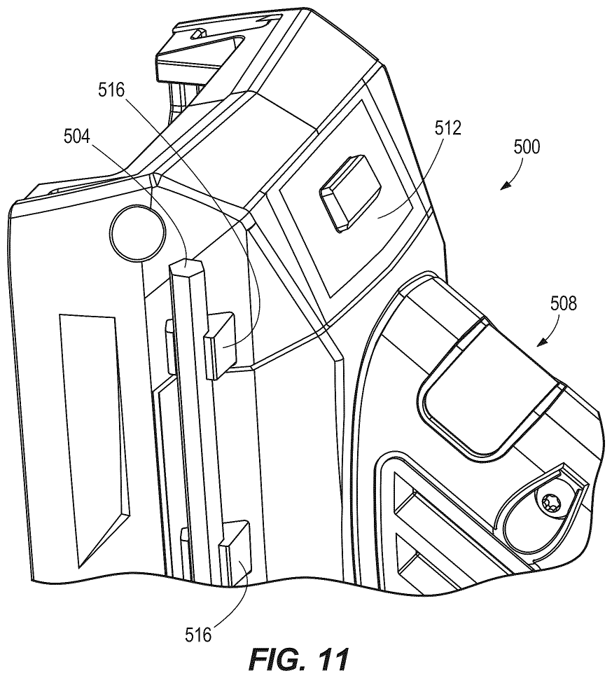

FIG. 11 illustrates another embodiment of a powered rebar cutter 500 including onboard storage for a hex key 504. The powered rebar cutter 500 includes a housing 508 having a first end 512 proximal to the battery pack (not shown). The first end 512 includes a pair of receptacles 516 that are configured to receive the hex key 504 with, for example, a snap-fit arrangement. The hex key 504 is removable from the receptacles 516 and used to remove the cutting blade 118 from the arbor 166 as described above.

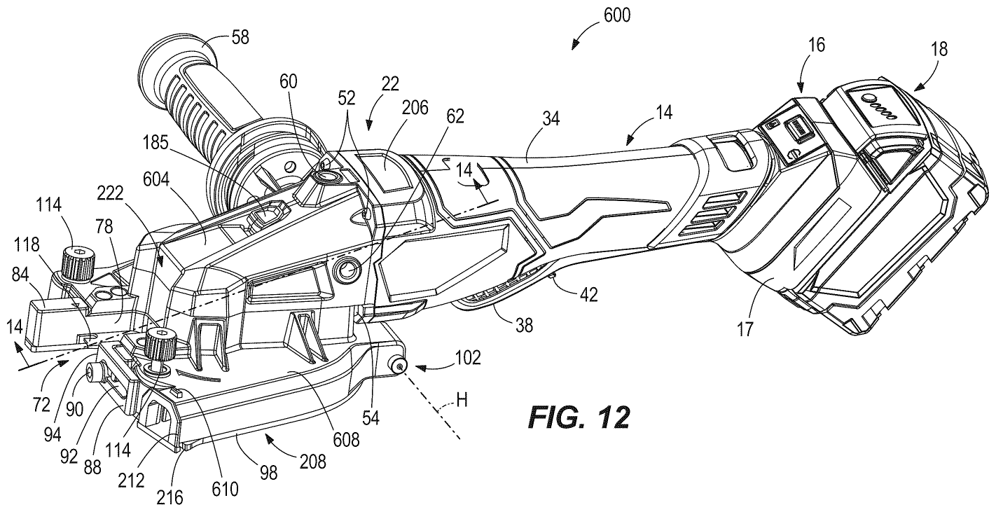

FIG. 12 illustrates another embodiment of a powered rebar cutter 600, with like features as the powered rebar cutter 10 being identified with like reference numerals. The powered rebar cutter 600 is like the powered rebar cutter 10 and therefore only differences will be discussed. The powered rebar cutter 600 includes a gear case 604 and a blade guard 608. The dust chute 208 of the blade guard 608 includes the rib 212, the notch 216, and a protrusion 610. The powered rebar cutter 600 includes an LED (not shown) that is located at a front end 222 of the powered rebar cutter 600.

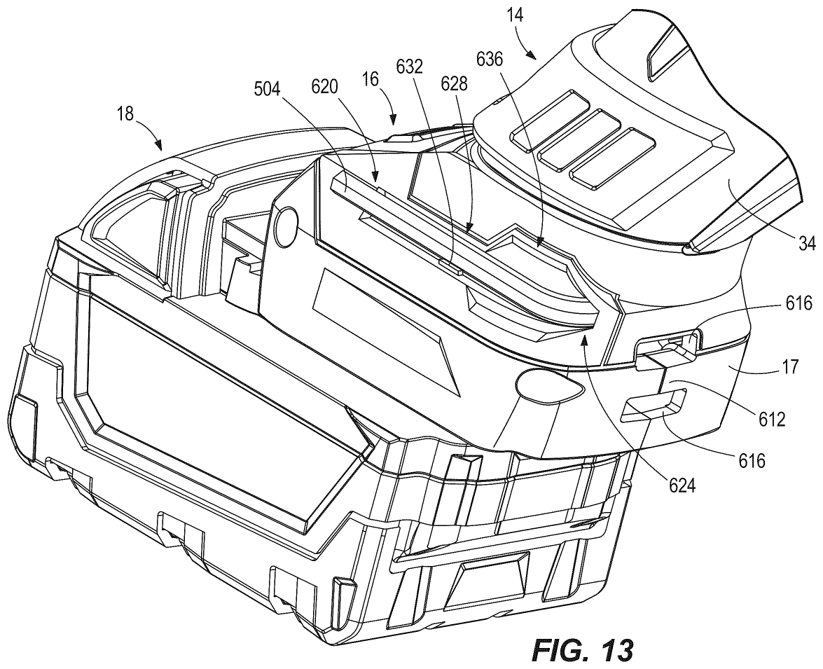

FIG. 13 illustrates the battery receptacle 17 of the powered rebar cutter 600. The battery receptacle 17 includes a tether hook 612. The tether hook 612 is configured to anchor a tether strap (not shown). In the illustrated embodiment, the tether hook 612 is flanked by recesses 616 of the battery receptacle 17. The recesses 616 are in communication with one another so the tether strap can encircle the tether hook 612. In other embodiments, the tether hook 612 stands proud on the battery receptacle 17 (e.g., without the recesses 616). The battery receptacle 17 of the powered rebar cutter 600 additionally includes a tool storage receptacle 620 configured to receive a tool (e.g., the hex key 504) for removing the cutting blade 118 from the arbor 166. The tool storage receptacle 620 includes a first recess 624 that extends transversely into the battery receptacle 17 and a second recess 628 that extends longitudinally along a side of the battery receptacle 17. The second recess 628 includes a projection 632 that is configured to hold the hex key 504 in place. Adjacent to the second recess 628 is a third recess 636. The third recess 636 is configured to provide an area for a user to grasp the hex key 504 to remove it from the tool storage receptacle 620.

As illustrated in FIG. 14, the only difference in the gear train 142 of the powered rebar cutter 600 is that the gear train 142 is received within a differently shaped gear case 604. A fist intersection point X is defined at an intersection of the rotational axis A of the arbor 166 and the top surface of the gear case 604 defining a plane G. A second intersection point Y is defined at an intersection of the rotational axis A of the arbor 166 and a bottom surface of the blade cover 98. A distance D2 between the first intersection point X and the second point Y is between 70 millimeters and 80 millimeters. In the illustrated embodiment, the distance D2 is 72 millimeters. The plane G is oriented at an angle a between 20 and 25 degrees relative to the plane B. In the illustrated embodiment, the angle a is 22 degrees.

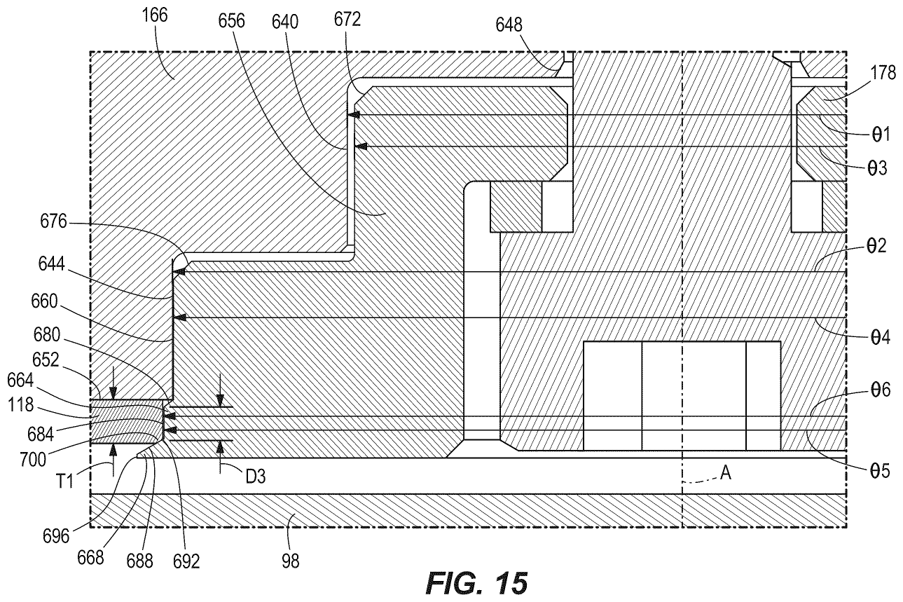

FIG. 15 illustrates the arbor 166 having an upper recess 640 and a contiguous lower recess 644. The upper recess 640 is adjacent a threaded aperture 648 that receives the fastener 182 for clamping the locking flange 178 to the arbor 166. The upper recess 640 defines an inner diameter Θ1 and the lower recess 644 defines a larger inner diameter Θ2. In the illustrated embodiment, the diameter Θ1 is between 16 millimeters and 20 millimeters. Specifically, in the illustrated embodiment, the diameter Θ1 is 18.4 millimeters. In the illustrated embodiment the diameter Θ2 is between 25 millimeters and 30 millimeters. Specifically, in the illustrated embodiment, the diameter Θ2 is 27.6 millimeters. The lower recess 644 is adjacent a bottom surface 652 of the arbor 166 that contacts the blade 118.

The locking flange 178 includes an upper cylindrical portion 656 received in the upper recess 640, a middle cylindrical portion 660 received in the lower recess 644, a lower cylindrical portion 664 adjacent the middle cylindrical portion 660, and a flange 668 adjacent the lower cylindrical portion 664. The upper cylindrical portion 656 defines a diameter Θ3 such that the upper cylindrical portion 656 is received within the upper recess 640. In other words, the diameter Θ3 is nominally less than the diameter Θ1. The upper cylindrical portion 656 includes a chamfer 672. The middle cylindrical portion 660 defines a diameter Θ4 such that the middle cylindrical portion 660 is received within the contiguous lower recess 644. In other words, the diameter Θ4 is nominally less than the diameter Θ2. The middle cylindrical portion 660 includes a chamfer 676. The lower cylindrical portion 664 defines a diameter 05 that is larger than the diameter Θ2 (FIG. 14). As such, the lower cylindrical portion 664 is not received within the lower recess 644 (i.e., the lower cylindrical portion 664 does not axially overlap along the rotational axis A of the arbor 166 with the lower recess 644). In the illustrated embodiment the diameter Θ5 is between 25 millimeters and 30 millimeters. Specifically, in the illustrated embodiment, the diameter Θ5 is 28 millimeters. The lower cylindrical portion 664 includes a chamfer 680. The chamfer 680 transitions between the middle cylindrical portion 660 to the lower cylindrical portion 664 (i.e., from the diameter Θ4 to the diameter Θ5). In some constructions, the locking flange 178 does not include the chamfer 680. In other words, the transition between the middle cylindrical portion 660 and the lower cylindrical portion 664 is a step.

The diameter Θ5 is nominally less than an inner diameter Θ6 of a blade aperture 684 of the blade 118 so the lower cylindrical portion 664 is received within the blade aperture 684. In the illustrated embodiments, the difference between the diameter Θ2 and the diameter Θ5 is approximately 0.4 millimeters. The lower cylindrical portion 664 includes an axial distance D3 defined along the rotational axis A from the middle cylindrical portion 660 to the flange 668. The axial distance D3 is less than a thickness T1 of the blade 118. In the illustrated embodiment, the thickness T1 is 1.2 millimeters. In other construction, the thickness T1 is greater than 1.2 millimeters or less than 1.2 millimeters.

The flange 668 includes a chamfer 688 extending from an inner edge 692 to an outer edge 696. In the illustrated embodiment, the inner edge 692 is disposed radially proximal to the rotational axis A of the arbor 166 relative to the outer edge 696. Also, the inner edge 692 is disposed axially proximal to the bottom surface 652 along the rotational axis A of the arbor 166 relative to the outer edge 696. The inner and outer edges 692, 696 are disposed radially outward from the lower recess 644 relative to the rotational axis A. The blade 118 includes a corresponding chamfer 700 configured to engage the flange 668 (more specifically, the chamfer 688) such that the blade 118 is disposed between the arbor 166 and the locking flange 178. The chamfer 700 is adjacent the blade aperture 684.

The locking flange 178 is configured to clamp the blade 118 axially along a direction parallel to the rotational axis A of the arbor 166. The diameter Θ6 of the blade aperture 684 is larger than the diameter Θ2 of the lower recess 644 such that the axial clamping force from the locking flange 178 is disposed radially outward from the lower recess 644 relative to the rotational axis A. As such, the blade 118 is fully supported on the bottom surface 652 since the diameter Θ2 of the lower recess 644 is smaller than the diameter Θ6 of blade aperture 684.

The blade 118 experiences less deflection from clamping the locking flange 178 onto the arbor 166 when the blade 118 is fully supported on the bottom surface 652. For instance, in a construction in which the diameter Θ6 of blade aperture 684 is smaller than the diameter Θ2 of the lower recess, an axial force of the locking flange 178 is not fully supported on the bottom surface 652. In other words, the blade aperture 684 is disposed radially inward from the lower recess 644 relative to the rotational axis A. As such, the blade aperture 684 is not axially supported by the bottom surface 652, possibly causing the inner periphery of the blade 118 to deflect upward in a direction parallel to the rotational axis A which, in turn, would cause an outer periphery 704 of the blade 118 to deflect downward or “cup.” In some constructions, the outer periphery 704 of the blade 118 could be deflected more than 1 millimeter in a direction parallel to the rotational axis A. In the illustrated construction with the blade aperture 684 being supported by the bottom surface 652, the displacement of an outer periphery of the blade 118 is less than 0.25 millimeters.

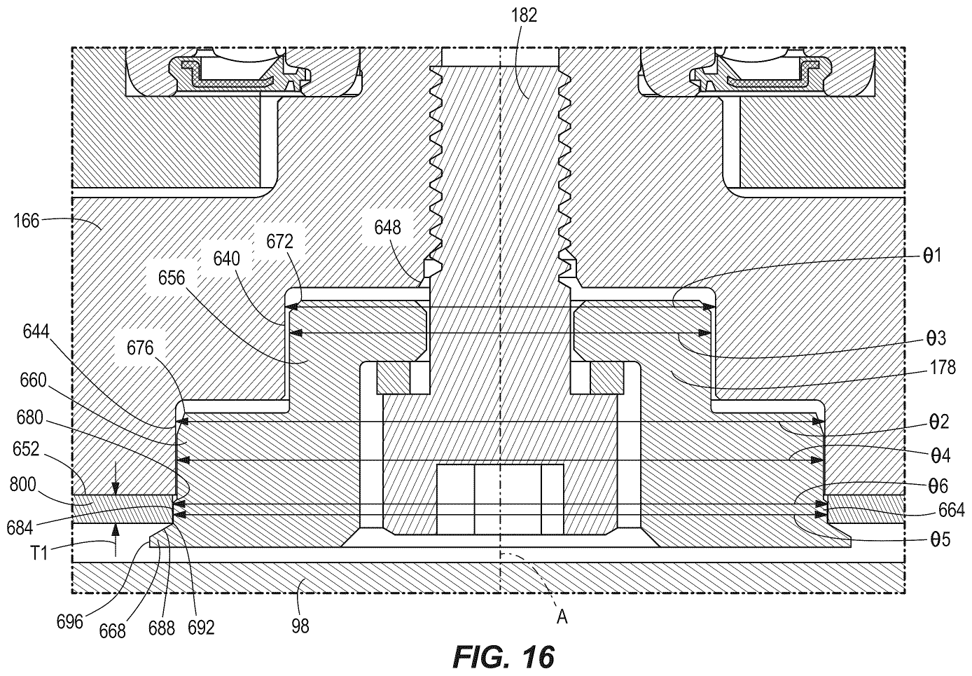

FIG. 16 illustrates another embodiment of a cutting blade 800 that is interchangeable with the cutting blade 118. In other words, the cutting blade 800 is compatible with the powered rebar cutters 10, 600. The blade 800 is similar to blade 118 so therefore only differences will be discussed. The blade 800 does not include a chamfer that corresponds with the chamfer 688 of the locking flange 178. As such, the blade 800 engages the inner edge 692 of the flange 668 when the locking flange 178 is coupled to the arbor 166 via the fastener 182. To accommodate the blade 800 without a chamfer corresponding to the chamfer 688 of the locking flange 178, the lower cylindrical portion 664 is lengthened along the rotational axis A such that the thickness T1 of the blade 800 remains the same as the blade 118.

Although the invention has been described in detail with reference to certain preferred embodiments, variations and modifications exist within the scope and spirit of one or more independent aspects of the invention as described.

Various features of the invention are set forth in the following claims.

1. A power tool comprising:
a housing defining a longitudinal axis;
a motor received within the housing and including a motor output shaft;
a gear case coupled to the housing;
a blade guard coupled to the gear case in which a rotating blade is at least partially received; and
a gear train at least partially received within the gear case and configured to transfer torque from the motor output shaft to the blade, the gear train including
an arbor to which the blade is coupled for co-rotation therewith,
a single intermediate shaft positioned between the motor output shaft and the arbor, the intermediate shaft configured to transfer torque from the motor output shaft to the arbor,
a pinion gear coupled for co-rotation with the motor output shaft, and
a ring gear coupled for co-rotation with the intermediate shaft and meshed with the pinion gear, the ring gear being located between a first plane defined by the blade and a parallel, second plane containing a rotational axis of the motor output shaft.

2. The power tool of claim 1, wherein the pinion gear is coupled to the motor output shaft by a left-hand thread arrangement.

3. The power tool of claim 2, wherein the arbor is rotated in a clockwise direction from a frame of reference along a rotational axis of the arbor looking at a top surface of the gear case.

4. The power tool of claim 1, wherein the motor output shaft is rotated in a clockwise direction from a frame of reference along a rotational axis of the motor output shaft looking at a front of the power tool.

5. The power tool of claim 4, wherein the intermediate shaft is oriented perpendicular to the motor output shaft.

6. The power tool of claim 5, further comprising a locking pin received by the gear case and configured for selective engagement with the ring gear to rotationally lock the ring gear to the gear case.

7. The power tool of claim 5, wherein the gear train includes a drive gear coupled to the intermediate shaft for co-rotation therewith and wherein the drive gear is located between the first plane and the ring gear.

8. The power tool of claim 7, wherein the gear train includes a driven gear coupled to the arbor for co-rotation therewith, wherein the driven gear is meshed with the drive gear, and wherein the intermediate shaft is oriented parallel to the arbor.

9. The power tool of claim 1, wherein the gear train includes
a pair of intermediate shaft bearings configured to rotatably support the intermediate shaft, and
a pair of arbor bearings configured to rotatably support the arbor,
wherein at least one of the intermediate shaft bearings and at least one of the arbor bearings are positioned in the gear case.

10. The power tool of claim 9, wherein a second intermediate shaft bearing of the pair of the intermediate shaft bearings and a second arbor bearing of the pair of the arbor bearings are positioned in the blade guard.

11. The power tool of claim 1, further comprising:
a rotational axis of the arbor;
a first intersection point defined by an intersection of the rotational axis of the arbor and a top surface of the gear case;
a blade cover pivotably coupled to the blade guard; and
a second intersection point defined by an intersection of the rotational axis of the arbor and a bottom surface of the blade cover,
wherein a distance between the first intersection point and the second intersection point is between 70 millimeters and 80 millimeters.

12. The power tool of claim 11, wherein the motor output shaft includes an end surface defining a third plane, and wherein a distance between the third plane and the rotational axis of the arbor is between 40 millimeters and 50 millimeters.

13. The power tool of claim 11, wherein the blade includes a diameter between 125 millimeters and 140 millimeters.

14. The power tool of claim 11, wherein the top surface of the gear case defines a fourth plane oriented at an angle between 20 degrees and 25 degrees relative to the first plane.

15. The power tool of claim 11, wherein the blade guard includes an opening extending in a direction of the longitudinal axis in which rebar is received during a cutting operation by a blade.

16. A powered rebar cutter comprising:
a housing defining a longitudinal axis;
a motor received within the housing;
a gear case coupled to the housing;
a blade guard coupled to the gear case, the blade guard including an opening extending in a direction of the longitudinal axis in which rebar is received during a cutting operation by a blade;
a gear train at least partially received within the gear case and configured to transfer torque from the motor to the blade; and
a lighting assembly configured to project light onto the opening to illuminate a portion of the blade exposed through the opening in the blade guard.

17. The powered rebar cutter of claim 16, wherein the lighting assembly includes a lens and a light source.

18. The powered rebar cutter of claim 17, wherein the light source is a light emitting diode.

19. The powered rebar cutter of claim 16, wherein the lighting assembly is disposed between the gear case and the blade guard.

20. The powered rebar cutter of claim 16, wherein the lighting assembly is disposed on the gear case.

21. The powered rebar cutter of claim 16, wherein the lighting assembly is a first lighting assembly disposed between the gear case and the blade guard, and wherein the powered rebar cutter further comprises a second lighting assembly disposed on the gear case.

22-41. (canceled)
